(19) United States
(12) Patent Application Publication
(10) Pub. No.: US 2025/0274950 A1
(43) Pub. Date: Aug. 28, 2025

(54) WIRELESS COMMUNICATION METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventors: Bin LIANG, Dongguan (CN); Yi ZHANG, Dongguan (CN)

(21) Appl. No.: 19/204,979

(22) Filed: May 12, 2025

Related U.S. Application Data
(63) Continuation of application No. PCT/CN2022/143477, filed on Dec. 29, 2022.

(51) Int. Cl. H04W 72/232

(52) U.S. Cl. CPC H04W 72/232

(57) ABSTRACT

A wireless communication method and apparatus, and a device and a storage medium. In the method, a network device sends first downlink control information (DCI) to a terminal device. The first DCI is used for simultaneously scheduling at least two carriers, the first DCI uses a first DCI format, the first DCI format includes a first indication field, the first indication field is used for indicating scheduling information of each of the at least two carriers, the bit width of the first indication field is a first bit width, and the first bit width is determined according to carriers that the first DCI can simultaneously schedule.

### CROSS-REFERENCE TO RELATED APPLICATION

This application is a continuation of International Application No. PCT/CN2022/143477 filed on Dec. 29, 2022, and entitled “WIRELESS COMMUNICATION METHOD AND APPARATUS, AND DEVICE AND STORAGE MEDIUM”, the disclosure of which is incorporated herein by reference in its entirety.

### TECHNICAL FIELD

Embodiments of the disclosure relates to the technical field of communications, and in particular to a method and apparatus for wireless communication, a device and a storage medium.

### BACKGROUND

In a 5th Generation (5G) system, i.e., a New Radio (NR) system, a network configures different Downlink Control Information (DCI) formats for a terminal device to adapt to different scenarios and meet scheduling requirements configured by the network. Different DCI formats may be distinguished by different DCI sizes or format indication fields in the DCI. In the NR system, one DCI can only schedule one data transmission on one carrier, i.e., one DCI can only schedule one data transmission.

In some scenarios, it needs to maximize data transmission scheduled by using limited configured Physical Downlink Control Channel (PDCCH) resources. Therefore, a solution in which one DCI schedules multiple data transmissions on multiple carriers (i.e., with one data transmission on each carrier) is provided. When one DCI is configured to schedule the multiple data transmissions on the multiple carriers, an indication field is used to indicate respective scheduling information for each of the multiple data transmission. However, a bit width of the indication field is not clearly defined, resulting in the terminal device being unable to successfully receive or decode the scheduling information carried by the DCI.

### SUMMARY

Embodiments of the disclosure provides a method and apparatus for wireless communication, a device and a storage medium.

An embodiment of the disclosure provides a method for wireless communication, which includes the following operations.

A network device sends first DCI to a terminal device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

A communication device provided by an embodiment of the disclosure may be the terminal device in the above method, and the communication device includes a processor and a memory. The memory is configured to store a computer program, and the processor is configured to call the computer program from the memory and run the computer program, to perform the method for wireless communication performed by the terminal device.

A communication device provided by an embodiment of the disclosure may be the network device in the above method, and the communication device includes a processor and a memory. The memory is configured to store a computer program, and the processor is configured to call the computer program from the memory and run the computer program, to perform the method for wireless communication performed by the network device.

### BRIEF DESCRIPTION OF THE DRAWINGS

The drawings described herein are used for providing a further understanding of the disclosure and constitute a part of the disclosure. Exemplary embodiments of the disclosure and description thereof are used for illustrating the disclosure and not intended to form an improper limit to the disclosure. In the drawings:

FIG. 1 is a schematic diagram illustrating an application scenario according to an embodiment of the disclosure.

FIG. 2 is a first optional flowchart illustrating a method for wireless communication according to an embodiment of the disclosure.

FIG. 3 is a second optional flowchart illustrating a method for wireless communication according to an embodiment of the disclosure.

FIG. 4 is a third optional flowchart illustrating a method for wireless communication according to an embodiment of the disclosure.

FIG. 5 is an optional schematic structural diagram of a network device according to an embodiment of the disclosure.

FIG. 6 is an optional schematic structural diagram of a terminal device according to an embodiment of the disclosure.

FIG. 7 is a schematic structural diagram of a communication device according to an embodiment of the disclosure.

FIG. 8 is a schematic structural diagram of a chip according to an embodiment of the disclosure.

FIG. 9 is a schematic block diagram of a communication system according to an embodiment of the disclosure.

### DETAILED DESCRIPTION

Technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

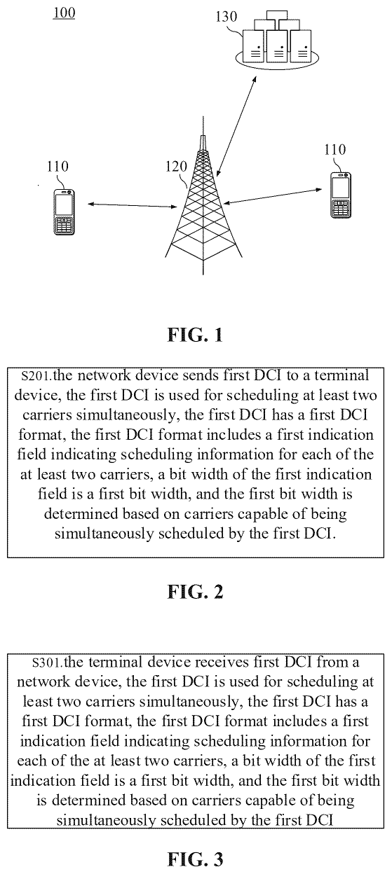

FIG. 1 is a schematic diagram illustrating an application scenario according to an embodiment of the disclosure.

As illustrated in FIG. 1, a communication system 100 may include a terminal device 110 and a network device 120. The network device 120 may communicate with the terminal device 110 through an air interface. Multi-service transmission is supported between the terminal device 110 and the network device 120.

It should be understood that the embodiments of the disclosure are described only using the communication system 100 as an example, but are not limited thereto. That is, the technical solutions of the embodiments of the disclosure may be applied to various communication systems, for example, a Long Term Evolution (LTE) system, an LTE Time Division Duplex (TDD) system, a Universal Mobile Telecommunication System (UMTS), an Internet of Things (IoT) system, a Narrow Band Internet of Things (NB-IoT) system, an enhanced Machine-Type Communication (eMTC) system, a 5G communication system (also called a NR communication system), a future communication system, and/or the like.

In the communication system 100 illustrated in FIG. 1, the network device 120 may be an access network device that communicates with the terminal device 110. The access network device may provide communication coverage for a specific geographical region and may communicate with the terminal device 110 (e.g., User Equipment (UE)) located in the coverage.

The access network device may be an Evolutional Node B (eNB or eNodeB) in an LTE system, a Next Generation Radio Access Network (NG RAN) device, a base station (gNB) in an NR system, a wireless controller in a Cloud Radio Access Network (CRAN), a relay station, an access point, a vehicle-mounted device, a wearable device, a hub, a switch, a network bridge, a router, a network device in a future evolutional Public Land Mobile Network (PLMN), and/or the like.

The terminal device 110 may be any terminal device, which includes but is not limited to a terminal device that is wired or wirelessly connected to the network device 120 or other terminal devices.

For example, the terminal device 110 may be referred to as an access terminal, UE, a user unit, a user station, a mobile station, a mobile terminal, a remote station, a remote terminal, a mobile device, a user terminal, a terminal, a wireless communication device, a user agent or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing devices connected to a wireless modem, a vehicle-mounted device, a wearable device, a terminal device in a 5G network or a terminal device in a future evolution network, or the like.

The terminal device 110 may be used for a Device to Device (D2D) communication.

The wireless communication system 100 may further include a core network device 130. The core network device 130 may be a 5G Core (5GC) device, for example, an Access and Mobility Management Function (AMF), an Authentication Server Function (AUSF), a User Plane Function (UPF), and/or a Session Management Function (SMF). Optionally, the core network device may also be an Evolved Packet Core (EPC) device in an LTE network, for example, a Session Management Function+Core Packet Gateway (SMF+PGW-C) device. It should be understood that the SMF+PGW-C can implement both the functions that can be implemented by the SMF and the PGW-C. In the process of network evolution, the above core network device may also be called by other names, or at least one new network entity may be formed by dividing the functions of the core network, which is not limited by the embodiment of the disclosure.

Connections may be established between various functional units of the communication system 100 through a next generation (NG) interface to realize communication.

For example, the terminal device establishes an air interface connection with the access network device through a Uu interface, for transmitting user plane data and control plane signaling. The terminal device may establish a control plane signaling connection with the AMF through an NG interface 1 (abbreviated as N1). The access network device, such as a next generation radio access base station (gNB), may establish a user plane data connection with the UPF through an NG interface 3 (abbreviated as N3). The access network device may establish a control plane signaling connection with the AMF through an NG interface 2 (abbreviated as N2). The UPF may establish a control plane signaling connection with the SMF through an NG interface 4 (abbreviated as N4). The UPF may interact user plane data with a data network through an NG interface 6 (abbreviated as N6). The AMF may establish a control plane signaling connection with the SMF through an NG interface 11 (abbreviated as N11). The SMF may establish a control plane signaling connection with a Policy Control Function (PCF) through an NG Interface 7 (abbreviated as N7).

FIG. 1 exemplarily illustrates one base station, one core network device, and two terminal devices. Optionally, the wireless communication system 100 may include multiple base stations and other number of terminal devices in the coverage of each base station, which is not limited by the embodiments of the disclosure.

It should be noted that FIG. 1 illustrates the system to which the disclosure is applicable by way of example only. The methods illustrated in the embodiments of the disclosure may also be applicable to other systems. In addition, the terms “system” and “network” are usually used interchangeably herein. Herein, the term “and/or” is merely an association relationship that describes associated objects, and represents that three relationships may exist. For example, A and/or B may represent three situations: independent existence of A, existence of both A and B, and independent existence of B. In addition, the character “/” used herein usually represents that the associated objects before and after the character “/” form an “or” relationship. It should also be understood that “indication/indicate/indicating” mentioned in the embodiments of the disclosure may be a direct indication, an indirect indication, or representation of an association relationship. For example, A indicates B, which may represent that A directly indicates B, e.g., B may be obtained from A; or may represent that A indirectly indicates B, e.g., A indicates C and B may be obtained from C; or may represent that there is an association relationship between A and B. It should also be understood that the “correspondence/correspond/corresponding” mentioned in the embodiments of the disclosure may represent that there is a direct correspondence or an indirect correspondence between two objects; or may represent an association relationship between the two objects, or a relationship between indication and being indicated, between configuration and being configured or the like. It should also be understood that the “predefinition/predefine”, “predefined by a protocol”, “pre-determination/pre-determine” or “predefined rule” mentioned in the embodiments of the disclosure may be implemented by pre-storing corresponding codes or tables in devices (e.g., including terminal devices and network devices) or by other ways that may be used to indicate related information, and the specific implementation thereof is not limited herein. For example, the predefinition may refer to what is defined in the protocol. It should also be understood that in the embodiments of the disclosure, the “protocol” may refer to standard protocols in the communication field, including such as an LTE protocol, a NR protocol, and related protocols to be applied in a future communication system, which are not limited herein.

In order to facilitate understanding of the technical solutions in the embodiments of the disclosure, the related art of the embodiments of the disclosure will be described below. The following related art may be used as an optional solution and arbitrarily combined with the technical solutions in the embodiments of the disclosure, and all of them belongs to the scope of protection of the embodiments of the disclosure.

A method for determining a bit width of an indication field in a DCI format

In the 5G system or the NR system, the network device configures different DCI formats for the terminal device to adapt to different scenarios and meet scheduling requirements configured by the network. Different DCI formats may be distinguished by different DCI sizes or format indication fields in the DCI. The bit width of each indication field in the DCI is predefined by a protocol or is determined based on configuration information.

The indication field in the DCI format may include at least one of: a Hybrid Automatic Repeat-reQuest (HARQ) process number indication field, an antenna port indication field, or a pre-coding information and layer number indication field.

In the protocol, in DCI format 0_0 or DCI format 1_0, a bit width of the HARQ process number indication field is fixed at 4 bits. In DCI format 0_0 or DCI format 1_0, a bit width of the HARQ process number indication field is determined based on whether high layer parameters harq-ProcessNumberSizeDCI-0-1 and harq-ProcessNumberSizeDCI-1-1 are configured; if a corresponding high layer parameter is configured, the bit width is 5 bits; otherwise, the bit width is 4 bits. In DCI format 0_2 and DCI format 1_2, a bit width is determined based on high layer parameters harq-ProcessNumberSizeDCI-0-2, harq-ProcessNumberSizeDCI-0-2-r17, harq-ProcessNumberSizeDCI-1-2, and harq-ProcessNumberSizeDCI-1-2-r17, and the bit width may be 0, 1, 2, 3 or 4 bit(s), or may be 0, 1, 2, 3, 4 or 5 bit(s).

A method for determining bit widths of the antenna port indication field, the pre-coding information and layer number indication field and a redundancy version (RV) indication field is similar to the method for determining the bit width of the HARQ process number indication field. The bit width of the antenna port indication field is determined based on configuration information related to the Demodulation Reference Signal (DMRS) or configuration information for the indication field. The bit width of the pre-coding information and layer number indication field is determined based on configured codebook information or codebook type. For example, in DCI format 0_1, if the number of scheduled Physical Uplink Shared Channel (PUSCH) indicated by a time domain resource assignment field is 1, the number of bits of the RV indication field is 2; in DCI format 0_2, the number of bits of the RV indication field is determined based on the high layer parameter numberOfBitsForRV-DCI-0-2, and the number of bits is 0, 1, or 2.

One DCI schedules Physical Downlink Shared Channel (PDSCH) or the PUSCH on multiple carriers.

In the 5G or NR system, one DCI can only schedule data transmission on one carrier. In some network configurations (e.g., a LTE and NR share frequency band), when there is a large amount of service data to be transmitted, or when the multiple carriers need to be transmitted simultaneously, it needs to maximize the data transmission scheduled by using limited configured PDCCH resources. Therefore, a solution in which one DCI (DCI format 0_X or DCI format 1_X) schedules multiple data transmissions on the multiple carriers (i.e., one data transmission on each carrier) is provided. When one DCI is configured to schedule the data transmissions on the multiple carriers, a carrier set (or called a set of cells) and a carrier combination (or called a cell combination) contained in the carrier set are configured. Each carrier set corresponds to a respective DCI format or a respective DCI format of size X, which can schedule a carrier combination composed of carriers in the carrier set. One carrier combination includes multiple carriers scheduled by one DCI simultaneously. Both the carrier set and the carrier combination in the carrier set are configured by a high layer signaling, and the number of carrier combinations in the carrier set is not limited to one. The number of carrier sets is not limited to one.

The DCI capable of scheduling multiple data transmissions on different carriers includes an indication field with the same function as that in a DCI scheduling one data transmission on one carrier. Some indication fields indicate the same information for the multiple data transmissions and have the same bit width as the corresponding indication field in the existing DCI, and some indication fields indicate respective scheduling information for the multiple data transmissions. The types of the indication fields include: Type-1, Type-2 and Type-3.

In Type-1, the DCI only contains one indication field, which is shared by data transmissions on multiple scheduled carriers, or which indicates scheduling information for data transmissions on different carriers through joint encoding. Type-1 is specifically divided into Type-1A, Type-1B and Type-1C.

In Type-2, the indication field in the DCI used for a certain type of information indicates the multiple scheduled carriers respectively, which can be understood as concatenating the indication information for the multiple carriers as the indication information of this indication field. The number of concatenated indication information is not less than the number of carriers in a carrier combination that is scheduled by the current DCI.

In Type-3, the indication field may be configured as Type 1 or Type 2.

In order to meet the requirement of scheduling data transmission on multiple carriers using one DCI, a new DCI format needs to be defined. In the existing DCI format, the bit width of each indication field is fixed or determined based on configuration. In the new DCI format, the bit widths of some indication fields are the same as that of the original DCI format, and some indication fields (e.g., the Type-2 field) respectively indicate the scheduling information for each data transmission, but there is no clear rule on how to determine the bit width. In the related art, each DCI format needs to have a clearly defined number of information bits based on an operation mode of the system, and correspondingly, the bit width of each indication field is definite after the configuration is determined. Only in this way, the terminal device can determine accurate scheduling information based on the number of information bits in the DCI and the bit width of each indication field. In the new DCI format, the method for determining bit widths of some indication fields are indefinite, which will prevent the terminal device from successfully receiving or decoding the DCI to obtain the accurate scheduling information, and the system performance will directly affected.

In order to facilitate understanding of the technical solutions in the embodiments of the disclosure, the technical solutions in the disclosure will be described in detail below with reference to specific embodiments. The above related art may be arbitrarily combined with the technical solutions in the embodiments of the disclosure as an optional solution, and all of them belong to the scope of protection of the embodiments of the disclosure. The embodiments of the disclosure include at least part of the following contents.

An embodiment of the disclosure provides a method for wireless communication, which is applied to a network device. As illustrated in FIG. 2, the method includes the following operations.

At operation S201, the network device sends first DCI to a terminal device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

An embodiment of the disclosure provides a method for wireless communication, which is applied to a terminal device. As illustrated in FIG. 3, the method includes the following operations.

At operation S301, the terminal device receives first DCI from a network device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

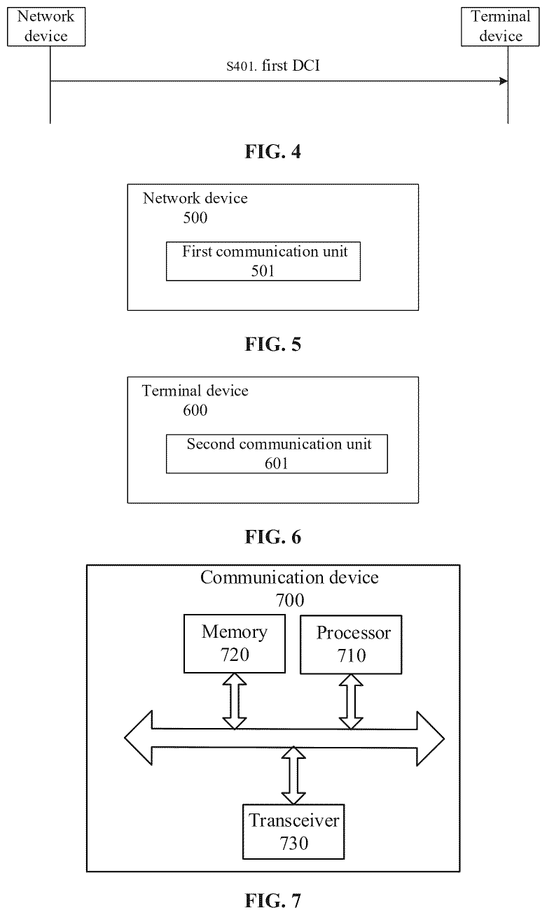

An embodiment of the disclosure provides a method for wireless communication, which is applied to a communication system including a terminal device and a network device. As illustrated in FIG. 4, the method includes the following operations.

At operation S401, the network device sends first DCI to the terminal device.

The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

Hereinafter, the method for wireless communication in any one of FIG. 2 to FIG. 4 provided by the embodiments of the disclosure will be further described.

The first DCI sent from the network device to the terminal device is used for scheduling at least two carriers simultaneously. It can be understood that the first DCI has a capability to schedule at least two carriers simultaneously. In practice, the carriers scheduled simultaneously by the first DCI sent from the network device to the terminal device may include one carrier or at least two carriers.

The first DCI simultaneously scheduling the at least two carriers can be understood as the first DCI simultaneously scheduling at least two data transmissions on the at least two carriers, and one carrier carries one data transmission.

The first DCI has the first DCI format, which may be DCI format 0_X or DCI format 1_X. DCI format 0_X is used for scheduling uplink transmission, such as the PUSCH. If the first DCI format is DCI format 0_X, all data transmissions simultaneously scheduled by the first DCI are the uplink transmissions. DCI format 1_X is used for downlink transmission, such as the PDSCH. If the first DCI format is the DCI format 1_X, all data transmissions simultaneously scheduled by the first DCI is the downlink transmissions.

The first DCI format includes the first indication field (i.e., a first information indication field). The first indication field may indicate one of the following scheduling information: time domain resource information, frequency domain resource information, Modulation and Coding Scheme (MCS) information, RV information, HARQ process information, priority information, Phase Tracking Reference Signal (PTRS) and DMRS association information (i.e., PTRS-DMRS association information), Sounding Reference Signal (SRS) request information, Channel Status Indicator (CSI) request information, and/or the like. Different first indication fields indicate different scheduling information.

A type of the first indication field is Type 2, and the first indication field indicates the scheduling information for each of the at least two carriers scheduled simultaneously. Herein, different first indication fields indicate different scheduling information, and thus, one first indication field indicates the scheduling information in the first indication field corresponding to a respective one of the at least two carriers scheduled simultaneously. It is understood that the first indication field includes indication information for each of the at least two carriers scheduled simultaneously, and the indication information for one carrier indicates the scheduling information for the carrier. In an example, if the first indication field indicates HARQ process number(s) and the first DCI simultaneously schedules carrier 1 and carrier 2, the first indication field indicates a HARQ process number corresponding to data transmission on carrier 1 and a HARQ process number corresponding to data transmission on carrier 2. In an example, if the first indication field indicates RV(s), the first DCI simultaneously schedules carrier 1, carrier 2 and carrier 3, the first indication field indicates a RV for carrier 1, a RV for carrier 2 and a RV for carrier 3.

The bit width of the first indication field is the first bit width, the first bit width is the number of bits occupied by the first indication field in the first DCI format, which can be understood as a maximum number of valid bits contained in the first indication field, the valid bits are bits in the first indication field that carry valid information, and the number of bits occupied by the valid information in the first indication field may be less than or equal to the first bit width.

The size of the first bit width is related to carriers capable of being simultaneously scheduled by the first DCI. In the embodiment of the disclosure, the multiple carriers capable of being simultaneously scheduled by the first DCI forms a carrier combination (i.e., a cell combination) corresponding to the first DCI. The first DCI can simultaneously schedule the carrier combination in a carrier group or the carrier combination in a first carrier set. It is understood that one carrier group includes at least one carrier set, and one carrier set includes at least one carrier combination. The first DCI formats corresponding to different carrier groups or different carrier sets may be the same or different.

In the embodiment of the disclosure, after the terminal device is configured with the carrier group or the carrier set, each carrier group or each carrier set is configured to include the carrier combination, and one carrier group or one carrier set is configured with a DCI format for scheduling the carrier combination in the carrier group or the carrier set.

It can be understood that the DCI format configured for scheduling the carrier combination in the carrier group or the carrier set is referred to as a DCI format corresponding to the carrier group or the carrier set. The first DCI with the first DCI format can schedule a carrier combination in a carrier group or a carrier set corresponding to the first DCI format. If the first DCI schedules the carrier combination in the carrier group, a concept of the carrier set is directly bypassed.

In some embodiments, the carrier group includes at least one of a Master Cell group (MCG), a Secondary Cell Group (SCG), or a Physical Uplink Control Channel (PUCCH) group.

For the first DCI format, the first DCI is configured with a corresponding carrier group or carrier set, and the carrier group or the carrier set is configured with the at least one carrier combination, the first DCI format is capable of scheduling any carrier combination in the carrier group or carrier set.

In an example, the first carrier set corresponding to the first DCI format is {cell 1, cell 2, cell 3, cell 4}, and the carrier combinations in the first carrier set include: {cell 1+cell 2}, {cell 1+cell 3}, {cell 1+cell 2+cell 3} and {cell 1+cell 3+cell 4}. Therefore, the carrier combinations capable of being scheduled by the first DCI format include: {cell 1+cell 2}, {cell 1+cell 3}, {cell 1+cell 2+cell 3} and {cell 1+cell 3+cell 4}.

The first DCI sent from the network device to the terminal device is used for scheduling the at least two carriers, the first DCI has the first DCI format, the first indication field in the first DCI format indicates the scheduling information for each of the at least two carriers, and the bit width of the first indication field is determined based on the carriers capable of being simultaneously scheduled by the first DCI. In this way, the bit width of the first indication field is clearly defined, so that when the network device sends the first DCI to the terminal device, the terminal device can receive and parse the first indication field in the DCI based on the first bit width, which ensures the scheduling information indicated by the first indication field is correctly transmitted between the network device and the terminal device.

In an embodiment of the disclosure, the method for determining the first bit width includes at least one of a first determination method and a second determination method.

In the first determination method, the first bit width is determined based on a first parameter and a second parameter.

In second determination method, the first bit width is determined based on the first parameter.

In the above determination methods, the first parameter is determined based on the carriers capable of being simultaneously scheduled by the first DCI.

### Regarding the First Determination Method

If a value of the first parameter is M and a value of the second parameter is N, the first bit width is determined based on M and N.

In some embodiments, the first bit width is determined based on a product of the first parameter and the second parameter. At this time, the first bit width is equal to M*N.

In some embodiments, the first parameter includes at least one of a first number or a second number.

The first number is a maximum number of the carriers capable of being simultaneously scheduled by the first DCI.

The second number is a number of carriers contained in a first carrier combination among at least one carrier combination corresponding to the first DCI, and the first carrier combination is a carrier combination with a maximum number of carriers among the at least one carrier combination.

The first number may be configured by the network device and represents the maximum number of carriers capable of being simultaneously scheduled by the first DCI. The number of carriers being simultaneously scheduled by the first DCI is less than or equal to the first number.

In an example, the first number configured for the first DCI is 3.

The second number is the maximum number of carriers contained in the carrier combination(s) corresponding to the first DCI. The carrier combination(s) corresponding to the first DCI is/are carrier combination(s) capable of being simultaneously scheduled by the first DCI. The at least one carrier combination corresponding to the first DCI includes carrier combination(s) contained in a carrier group or a first carrier set corresponding to the first DCI.

It can be understood that, the terms “cell” and “carrier” in the embodiments of the disclosure may be used interchangeably, for example, a carrier combination may also be described as a cell combination, and a carrier set may also be described as a cell set (or a set of cells).

In an example, the first carrier set corresponding to the first DCI format is {cell 1, cell 2, cell 3, cell 4}, and the carrier combinations in the first carrier set includes: {cell 1+cell 2}, {cell 1+cell 3}, {cell 1+cell 2+cell 3} and {cell 1+cell 3+cell 4}. Therefore, the carrier combinations capable of being scheduled by the first DCI format include: {cell 1+cell 2}, {cell 1+cell 3}, {cell 1+cell 2+cell 3} and {cell 1+cell 3+cell 4}, and thus, the second number corresponding to the first DCI is 4.

In some embodiments, the second parameter includes at least one of a third number and a fourth number.

The third number is predefined by a protocol.

The fourth number is determined based on configuration information in the first indication field corresponding to respective carriers in a carrier group or a first carrier set, and the first carrier set is a set of carriers corresponding to the first DCI format.

Herein, the fourth number is determined based on the configuration information in the first indication field corresponding to respective carriers capable of being scheduled by the first DCI. The configuration information may be understood as indication information (corresponding to the first indication field) for configuring the carrier.

The first carrier set is a carrier set corresponding to the first DCI format, the first carrier set may be understood as a carrier set in carrier sets configured for the terminal device, to which the carrier combination(s) capable of being scheduled by the first DCI format belongs, and the carrier combination(s) in the first carrier set is configured to be scheduled by the first DCI format.

In some embodiments, the configuration information includes at least one of:

scheduling information for the carrier; or

a number of bits corresponding to the carrier in the first indication field.

If the configuration information is the scheduling information for the carrier, the

fourth number is determined based on the number indicated by the scheduling information for each carrier in the first indication field. It should be understood that the scheduling information corresponding to the carrier may be pre-configured, and when the carrier is scheduled by the first DCI, the first indication field of the first DCI includes the scheduling information corresponding to the carrier.

In an example, the first indication field indicates the HARQ process number(s), and the fourth number is determined based on respective numbers of HARQ processes corresponding to the carriers in the carrier group or the first carrier set.

If the configuration information is the number of bits corresponding to the carrier, the fourth number is determined based on the respective number of bits corresponding to each carrier in the first indication field. It can be understood that the number of bits corresponding to the carrier may be pre-configured, and when the carrier is scheduled by the first DCI, the first indication field of the first DCI includes the scheduling information for the carrier, and the amount of bits occupied by the scheduling information for the carrier is the number of bits.

In an example, the first indication field indicates the HARQ process number(s), and the fourth number is determined based on the number of bits of a respective HARQ process number corresponding to each carrier in the carrier group or the first carrier set.

In some embodiments, the fourth number is one of fifth numbers, each of the fifth numbers corresponds to a respective carrier in the carrier group or the first carrier set, and is determined based on the configuration information for the respective carrier.

The fifth number corresponding to the carrier may be a number indicated by the scheduling information in the first indication field corresponding to the carrier or the number of bits occupied by scheduling information in the first indication field.

The fourth number is one of the fifth numbers corresponding to all carriers.

In an example, the first carrier combination corresponding to the first DCI includes cell 1, cell 2, cell 3, and cell 4, and the fourth number is one of: a fifth number for cell 1, a fifth number for cell 2, a fifth number for cell 3, or a fifth number for cell 4.

In some embodiments, the fourth number is a maximum one of the fifth numbers, or is a minimum one of the fifth numbers. Each of the fifth numbers corresponds to a respective carrier in the carrier group or the first carrier set

Herein, the fourth number is greater than or equal to 0, or the fourth number is greater than 0.

When the fifth number corresponding to one carrier included in the carrier group or the first carrier set is 0, the fourth number, which may be the minimum one of the fifth numbers corresponding to respective carriers in the carrier group or the first carrier set, may be 0. The fourth number may also be the minimum one of the fifth numbers other than 0 corresponding to respective carriers in the carrier group or the first carrier set.

In an example, the first indication field indicates the HARQ process number, and the first carrier set corresponding to the first DCI includes cell 1, cell 2, cell 3, and cell 4. The numbers of bits configured for HARQ process numbers corresponding to cell 1 to cell 4 are: 1, 1, 2 and 0, respectively. If the fourth number is the maximum one of the numbers of bits corresponding to the carriers, the fourth number is 2. If the fourth number is the minimum one of the numbers of bits corresponding to the carriers, the fourth number is 0. If the fourth number is the minimum one other than 0 of the numbers of the bits corresponding to the carriers, the fourth number is 1.

In the first determination method provided by the embodiments of the disclosure, the first parameter may be understood as a maximum number of the carriers capable of being simultaneously scheduled by the first indication field, and the second number may be understood as the number of bits occupied by one carrier in the first indication field, thereby determining the bit width of the first indication field based on the product of the first parameter and the second parameter. In this way, the number of bits of the first indication field is determined based on the information (e.g., the number of the HARQ processes) configured by the network device for the first indication field of the first DCI, thereby reducing signaling complexity.

When the second parameter is the fourth number and the fourth number is the maximum one of the fifth numbers for the carriers, the method for determining the first indication field of the first DCI format used for the configured carrier set is simple. The method saves the number of bits of the information indication field, and ensures that the first indication field can include the scheduling information for each carrier among the carriers scheduled simultaneously.

When the second parameter is the fourth number and the fourth number is the minimum one of the fifth numbers for the carriers, the number of bits of the information indication field is reduced to the greatest extent, thereby achieving compression of the size of the first DCI.

In the first determination method, the method for determining the first bit width may include at least one of:

a product of the first number and the third number;

a product of the second number and the third number;

a product of the first number and the fourth number; or

a product of the second number and the fourth number.

In a case that the first parameter is the first number, when determining the first bit width of the first indication field, the network device or the terminal device does not need to determine the carrier combination(s) capable of being scheduled by the first DCI, and only needs to determine the first bit width based on information configured by the network device.

In a case that the first parameter is the second number, when determining the first bit width of the first indication field, the network device or the terminal device first determines the carrier combination(s) capable of being scheduled by the first DCI, and then determines the first bit width based on analysis of the carrier combination(s) capable of being scheduled by the first DCI.

In a case that the second parameter is the third number, when determining the first bit width of the first indication field, the network device or the terminal device does not need to determine the carrier group or the first carrier set corresponding to the first DCI.

In a case that the second parameter is the fourth number, when determining the first bit width of the first indication field, the network device or the terminal device needs to determine the carrier group or the first carrier set corresponding to the first DCI, determine the fourth number through analysis of the carrier group or the first carrier set, and thereby determine the first bit width based on the fourth number.

### Regarding the Second Determination Method

If a value of the first parameter is M, the first bit width is determined based on M.

In some embodiments, the first parameter is one of sixth numbers, each of the sixth numbers corresponds to a respective carrier combination in a carrier group or a first carrier set, each of the sixth numbers is a sum of respective fifth numbers corresponding to all carriers in the respective carrier combination, each of the fifth numbers is determined based on configuration information for a respective one of the carriers in the respective carrier combination.

In the embodiment of the disclosure, for the carrier group or the first carrier set, each of different carrier combinations contained in the carrier group or the first carrier set corresponds to a respective sixth number, respectively. For one sixth number, the sixth number is sum of respective fifth numbers corresponding to all carriers in the respective carrier combination. It should be understood that, for one carrier combination, the sixth number corresponding to the carrier combination is the sum of fifth numbers corresponding to the carriers in the carrier combination. The first parameter is one of the sixth numbers corresponding to all carrier combinations.

In an example, the first carrier set corresponding to the first DCI format is {cell 1, cell 2, cell 3, cell 4}, and the carrier combination in the first carrier set includes: {cell 1+cell 2}, {cell 1+cell 3}, {cell 1+cell 2+cell 3} and {cell 1+cell 3+cell 4}. Therefore, the carrier combinations capable of being scheduled by the first DCI format include: {cell 1+cell 2}, {cell 1+cell 3}, {cell 1+cell 2+cell 3} and {cell 1+cell 3+cell 4}. Each of {cell 1+cell 2}, {cell 1+cell 3}, {cell 1+cell 2+cell 3} and {cell 1+cell 3+cell 4} corresponds to a respective sixth number. A sixth number corresponding to {cell 1+cell 2} is the sum of the fifth number corresponding to cell 1 and the fifth number corresponding to cell 2. A sixth number corresponding to {cell 1+cell 3} is the sum of the fifth number corresponding to cell 1 and the fifth number corresponding to cell 3. A sixth number corresponding to {cell 1+cell 2+cell 3} is the sum of the fifth number corresponding to cell 1, the fifth number corresponding to cell 2 and the fifth number corresponding to cell 3. A sixth number corresponding to {cell 1+cell 3+cell 4} is the sum of the fifth number corresponding to cell 1, the fifth number corresponding to cell 3 and the fifth number corresponding to cell 4. The first parameter corresponding to the first DCI is one of sixth numbers corresponding to all carrier combinations (i.e., {cell 1+cell 2}, {cell 1+cell 3}, {cell 1+cell 2+cell 3}, {cell 1+cell 3+cell 4}).

In some embodiments, the first parameter is a maximum one of the sixth numbers, or is a minimum one of the sixth numbers, each corresponding to a respective carrier combination in the carrier group or the first carrier set.

In the second determination method, the network device or the terminal device determines the number of bits required for the first indication field based on all the carrier combinations capable of being scheduled, thereby minimizing redundant bit information, reducing the size of the DCI format, and lowering decoding complexity.

In a practical application, the network device sends first indication information to the terminal device, and the first indication information indicates the method for determining the first bit width.

The network device notifies the terminal device of the method for determining the current first bit width through sending of the first indication information, so that the terminal device can determine the first bit width of the first indication field using a respective determination method.

In some embodiments, a number of valid bits contained in the first indication field in the first DCI is the first bit width or a second bit width, the second bit width is a bit width corresponding to a second carrier combination scheduled by the first DCI, and the second carrier combination includes the at least two carriers.

Herein, the valid bits in the first indication field are bits occupied by the valid information carried by the first indication field, and the number of valid bits in the first DCI is the first bit width or the second bit width. The second bit width is a bit width corresponding to the second carrier combination currently scheduled by the first DCI. It can be understood that the bit width of the first indication field is the first bit width, and the bits occupied by the valid information in the first indication field are all or part of the bits of the first indication field.

The valid information in the first indication field can be understood as information that the terminal device needs to parse.

In some embodiments, the second bit width is determined based on respective fifth numbers corresponding to carriers in the second carrier combination or a seventh number corresponding to the second carrier combination, the seventh number is a sum of fifth numbers corresponding to all carriers in the second carrier combination, and each of the fifth numbers is determined based on configuration information for a respective one of the carriers in the second carrier combination.

In an example, the first carrier set corresponding to the first DCI format is {cell 1, cell 2, cell 3, cell 4}, and the carrier combination in the first carrier set includes: {cell 1+cell 2}, {cell 1+cell 3}, {cell 1+cell 2+cell 3} and {cell 1+cell 3+cell 4}. Therefore, the carrier combinations capable of being scheduled by the first DCI format include: {cell 1+cell 2}, {cell 1+cell 3}, {cell 1+cell 2+cell 3} and {cell 1+cell 3+cell 4}. If a current carrier combination scheduled by the first DCI sent from the network device to the terminal device is {cell 1+cell 3}, the number of the first bits in the first indication field is the first bit width or the second bit width, and the second bit width is the sum of the fifth number corresponding to the cell 1 and the fifth number corresponding to the cell 3.

In some embodiments, the number of valid bits is less than or equal to the first bit width.

It is understood that the number of bits of valid information in the first indication field is not greater than the first bit width.

In some embodiments, parsing of valid information contained in the first indication field begins from a highest bit of the first indication field, or from a lowest bit of the first indication field.

When the terminal device receives the first DCI and parses the valid information in the first indication field in the first DCI, the terminal device begins parsing from the highest bit or the lowest bit of the first indication field.

The highest bit may be understood as a last bit received in the first indication field. The lowest bit may be understood as a first bit received in the first indication field.

It is understood that when the scheduling information indicated by the first DCI is mapped into scheduled carriers, the scheduled carriers are mapped in an ascending order or in a descending order of carrier identifications (i.e., cell IDs) of the respective scheduled carriers in the second carrier combination.

In some embodiments, if the number of the valid bits is less than the first bit width, at least one first bit has a preset value or is reserved, and each of the least one first bit is a bit in the first indication field other than the valid bits.

In a case that the first bit is reserved, the terminal device does not parse the first bit in the first indication field.

In an example, the first bit width is 9, and the first indication field in the first DCI indicating HARQ process numbers includes 9 bits, i.e., {b1, b2, b3, b4, b5, b6, b7, b8, b9}. When the first DCI format schedules a carrier combination 1 (i.e., {cell 1+cell 2}), the actual number of bits required by cell 1 is 3, and the actual number of bits required by cell 2 is 4, the {b1, b2, b3} indicates a HARQ process number for cell 1, the {b4, b5, b6, b7} indicates a HARQ process number for cell 2, and the remaining bits b8 to b9 are set to a preset value of 0 or 1, or are set to reserved. The terminal device parses the {b1, b2, b3} to obtain the HARQ process number for cell 1, parses the {b4, b5, b6, b7} to obtain the HARQ process number for cell 2, and parses or do not parse the remaining bits b8 to b9. When the first DCI format schedules the carrier combination 1 (i.e., {cell 1+cell 3}), the actual number of bits required by cell 1 is 3, and the actual number of bits required by cell 3 is 2, the {b1, b2, b3} indicates the HARQ process number for cell 1, {b4, b5} indicates a HARQ process number for cell 3, and the remaining bits b6 to b9 are set to a preset value of 0 or 1, or are set to reserved. The terminal device parses the {b1, b2, b3} to obtain the HARQ process number for cell 1, parses the {b4, b5} to obtain the HARQ process number for cell 3, and parses or do not parse the remaining bits b6 to b9.

In the embodiment of the disclosure, the terminal device can determine the number of bits required for the indication field for the HARQ process numbers based on all the carrier combinations capable of being scheduled, thereby minimizing redundant bit information, reducing the size of the DCI format, and lowering decoding complexity.

Hereinafter, the method for wireless communication provided by the embodiment of the disclosure will be further described.

The first DCI format is used for scheduling the multiple data transmissions (or for scheduling the multiple carriers), different data transmissions among the multiple data transmissions are respectively carried on different carriers, and one carrier carries one data transmission. The multiple data transmissions are either uplink transmissions (e.g., PUSCHs) or downlink transmissions (e.g., PDSCHs). The first DCI format includes the first information indication field. The first bit width corresponding to the first information indication field is determined based on the first parameter and/or the second parameter. The first information indication field indicates the scheduling information or transmission configuration information for the multiple data transmissions (or indicates the scheduling information or transmission configuration information for the data transmissions on the multiple carriers), and the scheduling information or transmission configuration information may include the time domain resource information, the frequency domain resource information, the MCS information, the RV information, the HARQ process information, the priority information, the PTRS-DMRS association information, the SRS request information, the CSI request information, and/or the like.

The method for determining the first bit width includes a first approach and a second approach.

In the first approach, the first bit width corresponding to the first information indication field is determined based on the product of the first parameter and the second parameter.

In second approach, the first bit width corresponding to the first information indication field is determined based on the first parameter.

In the first approach, the first parameter is predefined by the protocol, or a maximum one or a minimum one of third parameters corresponding to the carriers in the carrier set corresponding to the first DCI format.

A third parameter is determined based on the configuration information in the first information indication field corresponding to one carrier, and the third parameter is a number indicated by the configuration information for the carrier or a number of bits required by the configuration information. For example, the first information indication field indicates the HARQ process numbers, the third parameter is the number of HARQ processes configured for one carrier, or is the number of bits required to indicate the HARQ process number for one carrier. For example, the first information indication field indicates RV numbers, the third parameter is a RV configured for one carrier, or is the number of bits required to indicate the RV(s) for one carrier.

In the first approach, the second parameter is the maximum number of carriers or data transmissions capable of being scheduled by the first DCI format. The second parameter is determined based on first configuration information, or the second parameter is the maximum number of carriers contained in the carrier combination.

In the second approach, the first parameter is a maximum one of respective fourth parameters corresponding to the schedulable carrier combinations corresponding to the first DCI format. Each of the fourth parameters is a sum of respective third parameters corresponding to all carriers in a respective schedulable carrier combination.

In an embodiment of the disclosure, the schedulable carrier combinations corresponding to the first DCI format include at least one of:

all carrier combinations contained (configured) in the carrier set corresponding to the first DCI format, or

all (configured) carrier combinations in the carrier group (the MCG, the SCG, or the PUCCH group) configured for the terminal device.

In the first DCI format, the number of bits (or the number of valid information bits) corresponding to the first information indication field may be the first bit width corresponding to the first information indication field in the first DCI format. The number of bits (or the number of valid information bits) corresponding to the first information indication field may also be the second bit width corresponding to the first carrier combination scheduled by the first DCI (in this case, the first carrier combination needs to be parsed first to determine the second bit width, and then the indication information can be parsed), and the second bit width is determined based on the third parameters corresponding to the carriers in the first carrier combination or the fourth parameter corresponding to the first carrier combination.

The parsing of the valid information in the first information indication field begins from the highest bit or the lowest bit. The number of bits of the valid information is not greater than the first bit width (if the number of valid bits is less than the configured/determined bit width, the remaining bits other than the valid bits are set to a preset value (0 or 1), or are set to reserved (i.e., the terminal does not parse or ignores them)).

Each carrier set corresponds to one first DCI format, and the bit widths of the first DCI formats corresponding to different carrier sets can be the same or different. Each carrier set includes all carriers in all carrier combinations capable of being scheduled by the first DCI format. The carrier set(s) and the carrier combination(s) contained in the carrier set(s) are configured by the network.

The method for wireless communication provided by the embodiments of the disclosure can be implemented as, but is not limited to, the following first embodiment to the fifth embodiment.

### The First Embodiment

As illustrated in Table 1, the network configures {cell 1 to cell 4} as a first set of cells (i.e., the first carrier set), and also configures the carrier combinations (i.e., the cell combinations) in the first carrier set, the carriers in each carrier combination are capable of being simultaneously scheduled.

TABLE 1
Example of cell combination

| cell combination index | Co-scheduled cells/cell combination |
|---|---|
| 1 | cell 1 + cell 2 |
| 2 | cell 3 + cell 4 |
| 3 | cell 1 + cell 3 |
| 4 | cell 1 + cell 2 + cell 3 |
| 5 | cell 1 + cell 3 + cell 4 |

The DCI format for scheduling these carrier combinations is DCI format 0_X or DCI format 1_X. DCI format 0_X is used for scheduling uplink transmission (e.g., PUSCH) and format 1_X is used for scheduling downlink transmission (e.g., PDSCH). The maximum number of carriers capable of being scheduled by DCI format 0_X is 3, and the maximum number of carriers capable of being scheduled by DCI format 1_X is 3.

For each carrier in the first carrier set, a respective number of supported HARQ processes is configured, for example, cell 1-8, cell 2-16, cell 3-4, and cell 4-16. The number of bits of the indication information for indicating the HARQ process number is equal to a logarithm of the number of supported HARQ processes to base 2, that is, {log2 (8), log2 (16), log2 (4), log2 (16)}={3, 4, 2, 4} bits.

When determining the bit width of the HARQ process number indication field in DCI format 0_X, the following approaches may be adopted.

In approach 1A, the second number predefined by the protocol is 4 bits, and the maximum number of carriers capable of being scheduled by DCI format 0_X is 3, and thus, the bit width for the HARQ process number indication field in DCI format 0_X is 4*3=12 bits. Therefore, when transmitting or parsing DCI information based on DCI format 0_X, the bit information for the HARQ process number indication field is 12 bits. Each 4 bits are used for one carrier. If the number of the scheduled carriers is less than 3, the bits are assigned from the lowest bit or the highest bit, with each 4 bits corresponding to a respective scheduled carrier.

For the approach 1A, the method for determining the HARQ process number indication field in DCI format 0_X used for the configured carrier set is simple, which can be executed based merely on the configured maximum number of the scheduled carriers.

In approach 1B, in the first carrier set, the maximum number of bits for indicating the HARQ process number for each carrier is 4, and the maximum number of carriers capable of being scheduled by DCI format 0_X is 3, and thus, the bit width for the HARQ process number indication field in DCI format 0_X is 4*3=12 bits.

In approach 1C, in the first carrier set, the maximum one of the numbers of HARQ processes supported by the carriers is used to determine the number of bits for indicating the HARQ process number for each carrier. The maximum number of supported HARQ processes is 16, which corresponds to 4 (log2 (16)=4) bits for indicating the HARQ process number, and the maximum number of carriers capable of being scheduled by DCI format 0_X is 3, and thus, the bit width for the HARQ process number indication field in DCI format 0_X is 4*3=12 bits.

For the approach 1C, the number of bits of the information indication field can be appropriately reduced based on an actual configuration of the cell combination.

In approach 1D, in the first carrier set, the minimum number of bits for indicating the HARQ process number for the carriers is 2, and the maximum number of carriers capable of being scheduled by DCI format 0_X is 3, and thus, the bit width for the HARQ process number indication field in DCI format 0_X is 2*3=6 bits.

In approach 1E, the minimum one of the numbers of HARQ processes supported by the carriers is used to determine the number of bits for indicating the HARQ process number for each carrier. The minimum number of supported HARQ processes is 4, which corresponds to 2 (log2 (4)=2) bits for indicating the HARQ process number, and the maximum number of carriers capable of being scheduled by DCI format 0_X is 3, and thus, the bit width of the HARQ process number indication field in DCI format 0_X is 2*3=6 bits.

For the approach 1E, the number of information indication field bits is reduced to the greatest extent, thereby achieving compression of the size of the DCI.

In approach 1F, for each carrier combination in the first carrier set, the number of bits for the HARQ process number is calculated to obtain Table 2.

TABLE 2
Example of number of bits corresponding to cell combination

| cell combination | Co-scheduled cells/cell | number |
|---|---|---|
| index | combination | of bits |
| 1 | cell 1 + cell 2 | 3 + 4 = 7 |
| 2 | cell 3 + cell 4 | 2 + 4 = 6 |
| 3 | cell 1 + cell 3 | 3 + 4 = 7 |
| 4 | cell 1 + cell 2 + cell 3 | 3 + 4 + 2 = 9 |
| 5 | cell 1 + cell 3 + cell 4 | 3 + 4 + 2 = 9 |

The maximum one of the numbers of bits corresponding to all carrier combinations is 9, then the bit width of the HARQ process number indication field in DCI format 0_X is 9.

For the approach 1F, the number of bits required for the HARQ process number indication field is determined based on all the carrier combinations capable of being scheduled, thereby minimizing redundant bit information, reducing the size of the DCI format, and lowering decoding complexity.

When transmitting or parsing DCI information based on DCI format 0_X, the bit information for the HARQ process number indication field is 9 bits. The number of bits corresponding to each carrier is determined based on an actual scheduled carrier combination, and the parsing begins from the highest bit or the lowest bit. If the number of bits corresponding to the actual scheduled carrier combination is less than 9, the excess bit(s) is/are set to 0 or 1. Alternatively, in the DCI, the bit information for the HARQ process number indication field is equal to the number of bits corresponding to the actual scheduled carrier combination.

In the method for wireless communication provide by the first embodiment, the number of bits is determined based on the existing configuration information (i.e., the number of the HARQ processes), thereby reducing signaling complexity.

### The Second Embodiment

As illustrated in Table 1, the network configures {cell 1 to cell 4} as a first set of cells (i.e., the first carrier set), and also configures the carrier combinations (i.e., the cell combinations) in the first carrier set, the carriers in each carrier combination are capable of being simultaneously scheduled.

The DCI format for scheduling these carrier combinations is DCI format 0_X or DCI format 1_X. DCI format 0_X is used for scheduling uplink transmission (e.g., PUSCH) and format 1_X is used for scheduling downlink transmission (e.g., PDSCH). The maximum number of carriers capable of being scheduled by DCI format 0_X is 3, and the maximum number of carriers capable of being scheduled by DCI format 1_X is 3.

For each carrier in the first carrier set, the number of bits for indicating a respective HARQ process number corresponding to the cell is configured, for example, the number of bits for indicating the HARQ process number for cell 1 is 1 (i.e., cell 1-1), cell 2-3, cell 3-2, and cell 4-4. This configuration can be specific to DCI format 0_X, or can be reused as configuration information assigned to other DCI formats.

When determining the bit width of the HARQ process number indication field in DCI format 0_X, the following approaches may be adopted.

In approach 2A, the second number predefined by the protocol is 4 bits, and the maximum number of carriers capable of being scheduled by DCI format 0_X is 3, and thus, the bit width for the HARQ process number indication field in DCI format 0_X is 4*3=12 bits. Therefore, when transmitting or parsing DCI information based on DCI format 0_X, the bit information for the HARQ process number indication field is 12 bits. Each 4 bits are used for one carrier. If the number of the scheduled carriers is less than 3, the bits are assigned from the lowest bit or the highest bit, with each 4 bits corresponding to a respective scheduled carrier.

In approach 2B, in the first carrier set, the maximum number of bits for indicating the HARQ process number corresponding to each carrier is 4, and the maximum number of carriers capable of being scheduled by DCI format 0_X is 3, and thus, the bit width for the HARQ process number indication field in DCI format 0_X is 4*3=12 bits.

In approach 2C, in the first carrier set, the minimum number of bits for indicating the HARQ process number for each carrier is 1, and the maximum number of carriers capable of being scheduled by DCI format 0_X is 3, and thus, the bit width for the HARQ process number indication field in DCI format 0_X is 1*3=3 bits.

In approach 2D, the number of bits for the HARQ process number for each carrier combination in the first carrier set is calculated to obtain Table 3. The maximum one of the numbers of bits corresponding to all carrier combinations is 7, then the bit width of the HARQ process number indication field in DCI format 0_X is 7.

TABLE 3
Example of number of bits corresponding to cell combination

| cell combination | Co-scheduled cells/cell | number |
|---|---|---|
| index | combination | of bits |
| 1 | cell 1 + cell 2 | 1 + 3 = 4 |
| 2 | cell 3 + cell 4 | 2 + 4 = 6 |
| 3 | cell 1 + cell 3 | 1 + 2 = 3 |
| 4 | cell 1 + cell 2 + cell 3 | 1 + 3 + 2 = 6 |
| 5 | cell 1 + cell 3 + cell 4 | 1 + 2 + 4 = 7 |

When transmitting or parsing DCI information based on DCI format 0_X, the bit information for the HARQ process number indication field is 7 bits. The number of bits corresponding to each carrier is determined based on an actual scheduled carrier combination, and the parsing begins from the highest bit or the lowest bit. If the number of bits corresponding to the actual scheduled carrier combination is less than 7, the excess bit(s) is/are set to 0 or 1. Alternatively, in the DCI, the bit information for the HARQ process number indication field is equal to the number of bits corresponding to the actual scheduled carrier combination.

### The Third Embodiment

As illustrated in Table 4, the network configures {cell 1 to cell 4} as a first set of cells (i.e., the first carrier set), and also configures the carrier combinations (i.e., the cell combinations) in the first carrier set, the carriers in each carrier combination are capable of being simultaneously scheduled.

TABLE 4
Example of cell combination

| cell combination index | Co-scheduled cells/cell combination |
|---|---|
| 1 | cell 1 + cell 2 |
| 2 | cell 3 + cell 4 |
| 3 | cell 1 + cell 3 |
| 4 | cell 1 + cell 2 + cell 3 |
| 5 | cell 1 + cell 3 + cell 4 |
| 6 | cell 1 + + cell 2 + cell 3 + cell 4 |

The DCI format for scheduling these carrier combinations is DCI format 0_X or DCI format 1_X. DCI format 0_X is used for scheduling uplink transmission (e.g., PUSCH) and format 1_X is used for scheduling downlink transmission (e.g., PDSCH). The maximum number of carriers capable of being scheduled by DCI format 0_X is 4, and the maximum number of carriers capable of being scheduled by DCI format 1_X is 4.

For each carrier in the first carrier set, the number of bits for indicating a respective RV is configured, for example, cell 1-1, cell 2-1, cell 3-2, and cell 4-0. This configuration can be specific to DCI format 0_X, or can be reused as configuration information assigned to other DCI formats.

When determining the bit width of the RV indication field in DCI format 0_X, the following methods may be adopted.

In approach 3A, the second number predefined by the protocol is 2 bits, and the maximum number of carriers capable of being scheduled by DCI format 0_X is 4, and thus, the bit width for the RV indication field in DCI format 0_X is 2*4=8 bits. Therefore, when transmitting or parsing DCI information based on DCI format 0_X, the bit information for the RV indication field is 8 bits. Each 2 bits are used for one carrier. If the number of the scheduled carriers is less than 4, the bits are assigned beginning from the lowest bit or the highest bit, with each 2 bits for one scheduled carrier.

In approach 3B, in the first carrier set, the maximum one of the numbers of bits for indicating the RV corresponding to the carriers is 2, and the maximum number of carriers capable of being scheduled by DCI format 0_X is 4, and thus, the bit width for the RV indication field in DCI format 0_X is 2*4=8 bits.

In approach 3C, in the first carrier set, the minimum one of the numbers of bits for indicating the RV for the carriers is 0, and the maximum number of carriers capable of being scheduled by DCI format 0_X is 4, and thus, the bit width for the RV indication field in DCI format 0_X is 0*4=0 bit.

In approach 3D, the number of bits for the RV for each carrier combination in the first carrier set is calculated to obtain Table 5. The maximum one of the numbers of bits corresponding to all carrier combinations is 4, then the bit width for the RV indication field in DCI format 0_X is 4.

TABLE 5
Example of numbers of bits corresponding to cell combinations

| cell combination | Co-scheduled cells/cell | number |
|---|---|---|
| index | combination | of bits |
| 1 | cell 1 + cell 2 | 1 + 1 = 2 |
| 2 | cell 3 + cell 4 | 2 + 0 = 2 |
| 3 | cell 1 + cell 3 | 1 + 2 = 3 |
| 4 | cell 1 + cell 2 + cell 3 | 1 + 1 + 2 = 4 |
| 5 | cell 1 + cell 3 + cell 4 | 1 + 2 + 0 = 3 |
| 6 | cell 1 + + cell 2 + cell 3 + cell 4 | 1 + 1 + 2 + 0 = 4 |

When transmitting or parsing DCI information based on DCI format 0_X, the bit information for the RV indication field is 4 bits. The number of bits corresponding to each carrier is determined based on an actual scheduled carrier combination, and the parsing begins from the highest bit or the lowest bit. The number of bits corresponding to each scheduled carrier is determined based on the configuration. If the number of bits corresponding to the actual scheduled carrier combination is less than 4, the excess bit(s) is set to 0 or 1. Alternatively, in the DCI, the bit information for the RV indication field is equal to the number of bits corresponding to the actual scheduled carrier combination.

### The Fourth Embodiment

As illustrated in Table 4, the network configures {cell 1 to cell 4} as a first set of cells (i.e., the first carrier set), and also configures the carrier combinations (i.e., the cell combinations) in the first carrier set, the carriers in each carrier combination are capable of being simultaneously scheduled.

The DCI format for scheduling these carrier combinations is DCI format 0_X or DCI format 1_X. DCI format 0_X is used for scheduling uplink transmission (e.g., PUSCH) and format 1_X is used for scheduling downlink transmission (e.g., PDSCH). The maximum number of carriers capable of being scheduled by DCI format 0_X is 4, and the maximum number of carriers capable of being scheduled by DCI format 1_X is 4.

For each carrier in the first carrier set, the number of bits for indicating a respective PTRS-DMRS association is configured based on configured PTRS-UplinkConfig, transform precoder, and maxRank, for example, cell 1-2, cell 2-0, cell 3-2, and cell 4-2.

When determining the bit width of the PTRS-DMRS association indication field in DCI format 0_X, the following approaches may be adopted.

In approach 4A, the second number predefined by the protocol is 2 bits, and the maximum number of carriers capable of being scheduled by DCI format 0_X is 4, and thus, the bit width for the PTRS-DMRS association indication field in DCI format 0_X is 2*4=8 bits. Therefore, when transmitting or parsing DCI information based on DCI format 0_X, the bit information for the PTRS-DMRS association indication field is 8 bits. Each 2 bits are used for one carrier. If the number of the scheduled carriers is less than 4, the bits are assigned from the lowest bit or the highest bit, with each 2 bits for one scheduled carrier.

In approach 4B, in the first carrier set, the maximum number of bits for indicating the PTRS-DMRS association for each carrier is 2, and the maximum number of carriers capable of being scheduled by DCI format 0_X is 4, and thus, the bit width for the PTRS-DMRS association indication field in DCI format 0_X is 2*4=8 bits.

In approach 4C, in the first carrier set, the minimum one of the non-zero numbers of bits for indicating the PTRS-DMRS association for the carriers is 2, and the maximum one of the numbers of carriers capable of being scheduled by DCI format 0_X is 4, and thus, the bit width for the PTRS-DMRS association indication field in DCI format 0_X is 2*4=8 bits.

In approach 4D, the number of bits for the PTRS-DMRS association for each carrier combination in the first carrier set is calculated to obtain Table 6. The maximum number of bits corresponding to all carrier combinations is 6, then the bit width for the PTRS-DMRS association indication field in DCI format 0_X is 6.

TABLE 6
Example of numbers of bits corresponding to cell combinations

| cell combination | Co-scheduled cells/cell | number |
|---|---|---|
| index | combination | of bits |
| 1 | cell 1 + cell 2 | 2 + 0 = 2 |
| 2 | cell 3 + cell 4 | 2 + 2 = 4 |
| 3 | cell 1 + cell 3 | 2 + 2 = 4 |
| 4 | cell 1 + cell 2 + cell 3 | 2 + 0 + 2 = 4 |
| 5 | cell 1 + cell 3 + cell 4 | 2 + 2 + 2 = 6 |
| 6 | cell 1 + + cell 2 + cell 3 + cell 4 | 2 + 0 + 2 + 2 = 6 |

When transmitting or parsing DCI information based on DCI format 0_X, the bit information for the PTRS-DMRS association indication field is 4 bits. The number of bits corresponding to each carrier is determined based on an actual scheduled carrier combination, and the parsing begins from the highest bit or the lowest bit. The number of bits corresponding to each scheduled carrier is determined based on the configuration. If the number of bits corresponding to the actual scheduled carrier combination is less than 4, the excess bit(s) is set to 0 or 1. Alternatively, in the DCI, the bit information for the PTRS-DMRS association indication field is equal to the number of bits corresponding to the actual scheduled carrier combination.

### The Fifth Embodiment

As illustrated in Table 7, the network configures {cell 1 to cell 4} as a first set of cells (i.e., the first carrier set), and also configures the carrier combinations (i.e., the cell combinations) in the first carrier set, the carriers in each carrier combination are capable of being simultaneously scheduled.

TABLE 7
Example of cell combinations

| cell combination index | Co-scheduled cells/cell combination |
|---|---|
| 1 | cell 1 + cell 2 |
| 2 | cell 1 + cell 3 |
| 3 | cell 1 + cell 2 + cell 3 |

The DCI format for scheduling these carrier combinations is DCI format 0_X or DCI format 1_X. DCI format 0_X is used for scheduling uplink transmission (e.g., PUSCH) and format 1_X is used for scheduling downlink transmission (e.g., PDSCH). The maximum number of carriers capable of being scheduled by DCI format 0_X is 3, and the maximum number of carriers capable of being scheduled by DCI format 1_X is 3.

For each carrier in the first carrier set, a respective number of supported HARQ processes is configured, for example, cell 1-8, cell 2-16, cell 3-4, and cell 4-16. The number of bits of the indication information for indicating the HARQ process number is equal to a logarithm of the number of supported HARQ processes to base 2, that is, {log2 (8), log2 (16), log2 (4), log2 (16)}={3, 4, 2, 4} bits.

For the above approaches for determining the bit width of the indication field in the DCI format 0_X by using M*N (M is the maximum number, the minimum number, or the fixed number of bits corresponding to each carrier), it is assumed that each carrier corresponds to 4-bit information, and the bit width for the HARQ process number indication field in DCI format 0_X is 4*3=12 bits. When interpreting the HARQ process number indication field, the following methods may be adopted.

In approach 5A, when interpreting DCI format 0_X, the number of bits used for the HARQ process number indication field is 12. Each 4 bits correspond to one carrier, and these bits are mapped in an ascending order or in a descending order of the carrier identifications (cell IDs).

For example, the 12-bit information is {b1, b2, b3, b4, b5, b6, b7, b8, b9, b10, b11, b12}, which is mapped in a descending order of the carrier IDs (cell IDs).

If DCI format 0_X schedules the carrier combination 1 (i.e., {cell 1+cell 2}), the {b1, b2, b3, b4} indicates the HARQ process number for cell 1, the {b5, b6, b7, b8} indicates the HARQ process number for cell 2, and the remaining bits (i.e., b9 to b12) are set to a preset value of 0 or 1, or are set to reserved. The terminal does not parse the remaining bits.

If DCI format 0_X schedules the carrier combination 1 (i.e., {cell 1+cell 3}), the {b1, b2, b3, b4} indicates the HARQ process number for cell 1, the {b5, b6, b7, b8} indicates the HARQ process number for cell 3, and the remaining bits (i.e., b9 to b12) are set to a preset value of 0 or 1, or are set to reserved. The terminal does not parse the remaining bits.

If DCI format 0_X schedules the carrier combination 1 (i.e., {cell 1+cell 2+cell 3}), the {b1, b2, b3, b4} indicates the HARQ process number for cell 1, the {b5, b6, b7, b8} indicates the HARQ process number for cell 2, and the {b9, b10, b11, b12} indicates the HARQ process number for cell 3.

In approach 5B, the parsing is performed based on the actual number of required bits, and bit information corresponding to the carriers is mapped in an ascending order or in a descending order of the carrier identifications (cell IDs). For example, 12-bit information is {b1, b2, b3, b4, b5, b6, b7, b8, b9, b10, b11, b12}.

If DCI format 0_X schedules the carrier combination 1 (i.e., {cell 1+cell 2}), and the actual number of bits required by cell 1 is 3 and the actual number of bits required by cell 2 is 4, the {b1, b2, b3} indicates the HARQ process number for cell 1, the {b4, b5, b6, b7} indicates the HARQ process number for cell 2, and the remaining bits (i.e., b8 to b12) are set to a preset value of 0 or 1, or are set to reserved. The terminal does not parse the remaining bits.

If DCI format 0_X schedules the carrier combination 1 (i.e., {cell 1+cell 3}), and the actual number of bits required by cell 1 is 3 and the actual number of bits required by cell 3 is 2, the {b1, b2, b3} indicates the HARQ process number for cell 1, the {b4, b5} indicates the HARQ process number for cell 3, and the remaining bits (i.e., b6 to b12) are set to a preset value of 0 or 1, or are set to reserved. The terminal does not parse the remaining bits.

If DCI format 0_X schedules the carrier combination 1 (i.e., {cell 1+cell 2+cell 3}), and the actual number of bits required by cell 1 is 3, the actual number of bits required by cell 2 is 4, and the actual number of bits required by cell 3 is 2, the {b1, b2, b3} indicates the HARQ process number for cell 1, the {b4, b5, b6, b7} indicates the HARQ process number for cell 2, the {b8, b9} indicates the HARQ process number for cell 3, and the remaining bits (i.e., b10 to b12) are set to a preset value of 0 or 1, or area set to reserved. The terminal does not parse the remaining bits.

For the approach for determining the bit width of the indication field in DCI format 0_X based on the maximum number of bits corresponding to the carrier combination, the bit width of the HARQ process number indication field in DCI format 0_X is determined as the maximum one (i.e., 9 bits) of {3+4, 3+2, 3+4+2} based on the configured carrier combination. When interpreting the HARQ process number indication field, the following ways may be adopted.

The parsing is performed based on the actual number of required bits, and bit information corresponding to the carriers is mapped in an ascending order or in a descending order of the carrier identifications (cell IDs). For example, 9-bit information is {b1, b2, b3, b4, b5, b6, b7, b8, b9}, which is mapped in a descending order of carrier IDs (cell IDs).

If DCI format 0_X schedules the carrier combination 1 (i.e., {cell 1+cell 2}), and the actual number of bits required by cell 1 is 3 and the actual number of bits required by cell 2 is 4, the {b1, b2, b3} indicates the HARQ process number for cell 1, the {b4, b5, b6, b7} indicates the HARQ process number for cell 2, and the remaining bits (i.e., b8 to b9) are set to a preset value of 0 or 1, or are set to reserved, and the terminal does not parse the remaining bits.

If DCI format 0_X schedules the carrier combination 1 (i.e., {cell 1+cell 3}), and the actual number of bits required by cell 1 is 3 and the actual number of bits required by cell 3 is 2, the {b1, b2, b3} indicates the HARQ process number for cell 1, the {b4, b5} indicates the HARQ process number for cell 3, and the remaining bits (i.e., b6 to b9) are set to a preset value of 0 or 1, or are set to reserved, and the terminal does not parse the remaining bits.

If DCI format 0_X schedules the carrier combination 1 (i.e., {cell 1+cell 2+cell 3}), and the actual number of bits required by cell 1 is 3, the actual number of bits required by cell 2 is 4, and the actual number of bits required by cell 3 is 2, the {b1, b2, b3} indicates the HARQ process number for cell 1, the {b4, b5, b6, b7} indicates the HARQ process number for cell 2, and the {b8, b9} indicates the HARQ process number for cell 3.

The method for wireless communication according to the embodiments of the disclosure provides a clear way for determining the bit width of the Type-2 indication field in the DCI format capable of scheduling the data transmission on the multiple carriers, which is beneficial for determining the size of the DCI format and is beneficial for the terminal to perform DCI blind detection and information parsing.

The preferred embodiments of the disclosure have been described in detail with reference to the drawings, but the disclosure is not limited to the specific details in the above embodiments. Various simple modifications can be made to the technical solutions of the disclosure within the scope of the technical conception of the disclosure, all of which fall within the scope of protection of the disclosure. For example, the specific technical features described in the above specific embodiments/implementations may be combined in any suitable manner without conflict with each other, and various possible combinations are not further described in the disclosure in order to avoid unnecessary repetition. For another example, different embodiments/implementations of the disclosure can be combined arbitrarily, and the combined embodiments/implementations should also be regarded as the contents disclosed in the disclosure as long as they do not violate the idea of the disclosure. For another example, the embodiments/implementations and/or features in the embodiments/implementations described in the disclosure may be arbitrarily combined with the related art without conflict, and the solutions obtained through any combination should fall within the scope of protection of the disclosure.

It should be understood that the magnitude of serial numbers of the foregoing processes/operations do not mean execution sequences in various method embodiments of the disclosure. The execution sequences of the processes should be determined according to functions and internal logics of the processes, and should not be construed as any limitation to the implementation processes of the embodiments of disclosure. In addition, in the embodiments of the disclosure, the terms “downlink”, “uplink” and “sidelink” indicate a transmission direction of the signal or data. The term “downlink” indicates that the transmission direction of the signal or data is a first direction from a station to UE in a cell, the term “uplink” indicates that the transmission direction of the signal or data is a second direction from the UE in the cell to the station, and the term “sidelink” indicates that the transmission direction of the signal or data is a third direction from a first user equipment to a second user equipment. For example, a “downlink signal” means that the transmission direction of the signal is the first direction. In addition, in the embodiments of the disclosure, the term “and/or” is only an association relationship describing associated objects and represents that there are three relationships. Specifically, A and/or B may represent three situations: independent existence of A, existence of both A and B and independent existence of B. In addition, the character “/” used herein usually represents that the associated objects before and after the character form an “or” relationship.

FIG. 5 is a schematic diagram illustrating a structural composition of a network device according to an embodiment of the disclosure. As illustrated in FIG. 5, the network device 500 includes a first communication unit 501.

The first communication unit 501 is configured to send first DCI to a terminal device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

In a practical application, the network device 500 further includes a storage unit configured to store at least one scheduling group corresponding to the first DCI and configuration information corresponding to each carrier in a carrier group and a first carrier set.

In some embodiments, the first bit width is determined based on a first parameter and a second parameter, and the first parameter is determined based on the carriers capable of being simultaneously scheduled by the first DCI.

In some embodiments, the first bit width is determined based on a product of the first parameter and the second parameter.

In some embodiments, the first parameter includes at least one of: a first number or a second number.

The first number is a maximum number of the carriers capable of being simultaneously scheduled by the first DCI.

The second number is a number of carriers contained in a first carrier combination among at least one carrier combination corresponding to the first DCI, and the first carrier combination is a carrier combination with a maximum number of carriers among the at least one carrier combination.

In some embodiments, the second parameter includes at least one of: a third number or a fourth number.

The third number is predefined by a protocol.

The fourth number is determined based on configuration information in the first indication field corresponding to respective carriers in a carrier group or a first carrier set, and the first carrier set is a set of carriers corresponding to the first DCI format.

In some embodiments, the fourth number is one of fifth numbers, each of the fifth numbers corresponds to a respective carrier in the carrier group or the first carrier set, and the fifth number is determined based on the configuration information for the respective carrier.

In some embodiments, the fourth number is a maximum one of the fifth numbers, or is a minimum one of the fifth numbers, each of the fifth numbers corresponds to a respective carrier in the carrier group or the first carrier set.

In some embodiments, the first bit width is determined based on a first parameter, the first parameter is determined based on the carriers capable of being simultaneously scheduled by the first DCI.

In some embodiments, the first parameter is one of sixth numbers, each of the sixth numbers corresponds to a respective carrier combination in a carrier group or a first carrier set, the sixth number is a sum of respective fifth numbers corresponding to all carriers in the respective carrier combination, each of the fifth numbers is determined based on configuration information for a respective one of the carriers in the respective carrier combination.

In some embodiments, the first parameter is a maximum one of the sixth numbers, or is a minimum one of the sixth numbers, each of the sixth numbers corresponding to a respective carrier combination in the carrier group or the first carrier set.

In some embodiments, the carrier group includes at least one of: a MCG, a SCG, or a PUCCH group.

In some embodiments, a number of valid bits contained in the first indication field in the first DCI is the first bit width or a second bit width, the second bit width is a bit width corresponding to a second carrier combination scheduled by the first DCI, and the second carrier combination includes the at least two carriers.

In some embodiments, the second bit width is determined based on respective fifth numbers corresponding to carriers in the second carrier combination or a seventh number corresponding to the second carrier combination, the seventh number is a sum of respective fifth numbers corresponding to all carriers in the second carrier combination, each of the fifth numbers is determined based on configuration information for a respective one of the carriers in the second carrier combination.

In some embodiments, the number of valid bits is less than or equal to the first bit width.

In some embodiments, parsing of valid information contained in the first indication field begins from a highest bit of the first indication field, or from a lowest bit of the first indication field.

In some embodiments, if the number of the valid bits is less than the first bit width, at least one first bit has a preset value or is reserved, and each of the least one first bit is a bit in the first indication field other than the valid bits.

In some embodiments, the configuration information includes at least one of: the scheduling information for the carrier or a number of bits corresponding to the carrier.

FIG. 6 is a schematic diagram illustrating a structural composition of a terminal device according to an embodiment of the disclosure. As illustrated in FIG. 6, the network device 600 includes a second communication unit 601.

The second communication unit 601 is configured to receive first DCI from a network device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

In a practical application, the terminal device 600 further includes a storage unit configured to store at least one scheduling group corresponding to the first DCI and configuration information corresponding to each carrier in a carrier group and a first carrier set.

In some embodiments, the first bit width is determined based on a first parameter and a second parameter, and the first parameter is determined based on the carriers capable of being simultaneously scheduled by the first DCI.

In some embodiments, the first bit width is determined based on a product of the first parameter and the second parameter.

In some embodiments, the first parameter includes at least one of: a first number or a second number.

The first number is a maximum number of the carriers capable of being simultaneously scheduled by the first DCI.

The second number is a number of carriers contained in a first carrier combination among at least one carrier combination corresponding to the first DCI, and the first carrier combination is a carrier combination with a maximum number of carriers among the at least one carrier combination.

In some embodiments, the second parameter includes at least one of: a third number or a fourth number.

The third number is predefined by a protocol.

The fourth number is determined based on configuration information in the first indication field corresponding to respective carriers in a carrier group or a first carrier set, and the first carrier set is a set of carriers corresponding to the first DCI format.

In some embodiments, the fourth number is one of: fifth numbers, each of the fifth numbers corresponds to a respective carrier in the carrier group or the first carrier set, and the fifth number is determined based on the configuration information for the respective carrier.

In some embodiments, the fourth number is a maximum one of the fifth numbers, or is a minimum one of the fifth numbers.

In some embodiments, the first bit width is determined based on a first parameter, the first parameter is determined based on the carriers capable of being simultaneously scheduled by the first DCI.

In some embodiments, the first parameter is one of sixth numbers, each of the sixth numbers corresponds to a respective carrier combination in a carrier group or a first carrier set, the sixth number is a sum of respective fifth numbers corresponding to all carriers in the respective carrier combination, each of the fifth numbers is determined based on configuration information for a respective one of the carriers in the respective carrier combination.

In some embodiments, the first parameter is a maximum one of the sixth numbers, or is a minimum one of the sixth numbers, each of the sixth numbers corresponding to a respective carrier combination in the carrier group or the first carrier set.

In some embodiments, the carrier group includes at least one of: a MCG, a SCG, or a PUCCH group.

In some embodiments, a number of valid bits contained in the first indication field in the first DCI is the first bit width or a second bit width, the second bit width is a bit width corresponding to a second carrier combination scheduled by the first DCI, and the second carrier combination includes the at least two carriers.

In some embodiments, the second bit width is determined based on respective fifth numbers corresponding to carriers in the second carrier combination or a seventh number corresponding to the second carrier combination, the seventh number is a sum of respective fifth numbers corresponding to all carriers in the second carrier combination, each of the fifth numbers is determined based on configuration information for a respective one of the carriers in the second carrier combination.

In some embodiments, the number of valid bits is less than or equal to the first bit width.

In some embodiments, parsing of valid information contained in the first indication field begins from a highest bit of the first indication field, or from a lowest bit of the first indication field.

In some embodiments, if the number of the valid bits is less than the first bit width, at least one first bit has a preset value or is reserved, and each of the least one first bit is a bit in the first indication field other than the valid bits.

In some embodiments, the configuration information includes at least one of: the scheduling information for the carrier or a number of bits corresponding to the carrier.

It should be understood by those skilled in the art that the descriptions about the terminal devices and the network device in the embodiments of the disclosure may be understood with reference to the descriptions about the methods for wireless communication in the embodiments of the disclosure.

FIG. 7 is a schematic structural diagram of a communication device according to an embodiment of the disclosure. The communication device may be a terminal device or a network device. The communication device 700 illustrated in FIG. 7 includes a processor 710. The processor 710 is configured to call a computer program from a memory and run the computer program, to implement the methods in the embodiments of the disclosure.

Optionally, as illustrated in FIG. 7, the communication device 700 may further include a memory 720. Herein, the processor 710 is configured to call the computer program from the memory 720 and run the computer program, to implement the methods in the embodiments of the disclosure.

The memory 720 may be a separate device independent of the processor 710 or may be integrated into the processor 710.

Optionally, as illustrated in FIG. 7, the communication device 700 may further include a transceiver 730, and the processor 710 may control the transceiver 730 to communicate with other devices. Specifically, the transceiver 730 sends information or data to the other devices or receives information or data from the other devices.

The transceiver 730 may include a transmitter and a receiver. The transceiver 70 may further include an antenna. The number of the antennas may be one or more.

Optionally, the communication device 700 may specifically be a network device in the embodiments of the disclosure, and the communication device 700 may implement corresponding processes implemented by the network device in each method of the embodiments of the disclosure. For simplicity, elaborations are omitted herein.

Optionally, the communication device 700 may specifically be a mobile terminal/a terminal device in the embodiments of the disclosure, and the communication device 700 may implement corresponding processes implemented by the mobile terminal/the terminal device in each method of the embodiments of the disclosure. For simplicity, elaborations are omitted herein.

FIG. 8 is a schematic structural diagram of a chip according to an embodiment of the disclosure. The chip 800 illustrated in FIG. 8 includes a processor 810, and the processor 810 is configured to call a computer program from a memory and run the computer program, to implement the methods in the embodiments of the disclosure.

Optionally, as illustrated in FIG. 8, the chip 800 may further include a memory 820. The processor 810 is configured to call the computer program from the memory 820 and run the computer program, to implement the methods in the embodiments of the disclosure.

The memory 820 may be a separate device independent of the processor 810 or may be integrated into the processor 810.

Optionally, the chip 800 may further include an input interface 830. The processor 810 may be configured to control the input interface 830 to communicate with other devices or chips. Specifically, the input interface may acquire information or data from the other devices or chips.

Optionally, the chip 800 may further include an output interface 840. The processor 810 may be configured to control the output interface 840 to communicate with other devices or chips. Specifically, the output interface may output information or data to the other devices or chips.

Optionally, the chip can be applied to the network device in the embodiments of the disclosure, and the chip can implement corresponding processes implemented by the network device in each method of the embodiments of the disclosure. For simplicity, elaborations are omitted herein.

Optionally, the chip can be applied to the mobile terminal/the terminal device, in the embodiments of the disclosure, and the chip can implement corresponding processes implemented by the mobile terminal/the terminal device in each method of the embodiments of the disclosure. For simplicity, elaborations are omitted herein.

It is to be understood that the chip mentioned in the embodiments of the disclosure may also be called a system-level chip, a system chip, a chip system or a system on chip, or the like.

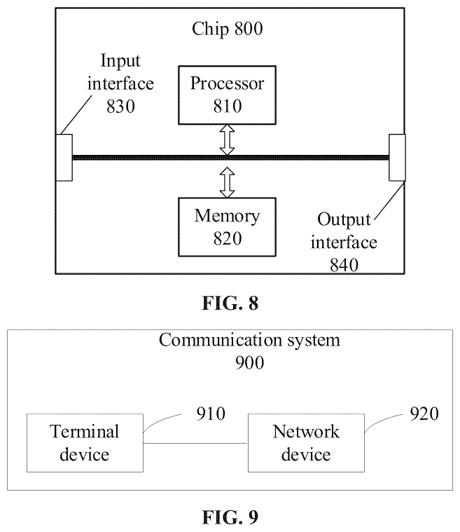

FIG. 9 is a schematic block diagram of a communication system according to an embodiment of the disclosure. As illustrated in FIG. 9, the communication system 900 includes a terminal device 910 and a network device 920.

Herein, the terminal device 910 may be configured to implement the corresponding functions implemented by the terminal device in the above methods, and the network device 920 may be configured to implement the corresponding functions implemented by the network device in the above methods. For simplicity, elaborations are omitted herein.

It should be understood that the processor in the embodiments of the disclosure may be an integrated circuit chip and has a signal processing capability. In an implementation process, each operation in the method embodiments may be completed by an integrated logical circuit in a hardware form in the processor or instructions in a software form. The above processor may be a general purpose processor, a Digital Signal Processor (DSP), an Application Specific Integrated Circuit (ASIC), a Field Programmable Gate Array (FPGA), or other programmable logic devices, a discrete gate or a transistor logical device, or a discrete hardware component, for implementing or executing each method, operation and logical block diagram disclosed in the embodiments of the disclosure. The general purpose processor may be a microprocessor or the processor may also be any conventional processor and the like. The operations in the methods disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM), an Electrically Erasable PROM (EEPROM) and a register. The storage medium is located in a memory, and the processor reads information from the memory, and completes the operations in the above methods in combination with the hardware of the processor.

It can be understood that the memory in the embodiments of the disclosure may be a volatile memory or a non-volatile memory, or may include both the volatile and the non-volatile memories. The non-volatile memory may be a ROM, a PROM, an Erasable PROM (EPROM), an EEPROM or a flash memory. The volatile memory may be a RAM, and is used as an external cache. By way of illustrative but not limiting description, RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM). It is to be noted that the memory for the system and method described in the disclosure is intended to include, but not limited to, these and any other suitable types of memories.

It should be understood that the above description of the memory is exemplary and non-limiting. For example, the memory in the embodiments of the disclosure may also be an SRAM, a DRAM, an SDRAM, a DDR SDRAM, an ESDRAM, an SLDRAM, a DR RAM and the like. That is, the memory in the embodiments of the disclosure is intended to include, but not limited to, these and any other suitable types of memories.

An embodiment of the disclosure further provides a computer-readable storage medium configured to store a computer program.

Optionally, the computer-readable storage medium can be applied to the network device in the embodiments of the disclosure, and the computer program causes a computer to execute corresponding processes implemented by the network device in each method of the embodiments of the disclosure. For simplicity, elaborations are omitted herein.

Optionally, the computer-readable storage medium can be applied to the mobile terminal/the terminal device in the embodiments of the disclosure, and the computer program causes a computer to execute corresponding processes implemented by to the mobile terminal/the terminal device in each method of the embodiments of the disclosure. For simplicity, elaborations are omitted herein.

An embodiment of the disclosure further provides a computer program product including computer program instructions.

Optionally, the computer program product can be applied to the network device in the embodiments of the disclosure, and the computer program instructions cause a computer to execute corresponding processes implemented by the network device in each method of the embodiments of the disclosure. For simplicity, elaborations are omitted herein.

Optionally, the computer program product can be applied to the mobile terminal/the terminal device in the embodiments of the disclosure, and computer program instructions cause a computer to execute corresponding processes implemented by to the mobile terminal/the terminal device in each method of the embodiments of the disclosure. For simplicity, elaborations are omitted herein.

An embodiment of the disclosure further provides a computer program.

Optionally, the computer program can be applied to the network device in the embodiments of the disclosure, and when the computer program is run on a computer, the computer executes corresponding processes implemented by the network device in each method of the embodiments of the disclosure. For simplicity, elaborations are omitted herein.

Optionally, the computer program can be applied to the mobile terminal/the terminal device in the embodiments of the disclosure, and when the computer program is run on a computer, the computer executes corresponding processes implemented by the mobile terminal/the terminal device in each method of the embodiments of the disclosure. For simplicity, elaborations are omitted herein.

Embodiments of the disclosure provides a method and apparatus for wireless communication, a device and a storage medium.

An embodiment of the disclosure provides a method for wireless communication, which includes the following operations.

A network device sends first DCI to a terminal device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

An embodiment of the disclosure provides a method for wireless communication, which includes the following operations.

A terminal device receives first DCI from a network device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

An embodiment of the disclosure provides a network device, which includes a first communication unit.

The first communication unit is configured to send first DCI to a terminal device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

An embodiment of the disclosure provides a terminal device, which includes a second communication unit.

The second communication unit is configured to receive first DCI from a network device. The first DCI is used for scheduling at least two carriers simultaneously, the first DCI has a first DCI format, the first DCI format includes a first indication field indicating scheduling information for each of the at least two carriers, a bit width of the first indication field is a first bit width, and the first bit width is determined based on carriers capable of being simultaneously scheduled by the first DCI.

A communication device provided by an embodiment of the disclosure may be the terminal device in the above method, and the communication device includes a processor and a memory. The memory is configured to store a computer program, and the processor is configured to call the computer program from the memory and run the computer program, to perform the method for wireless communication performed by the terminal device.

A communication device provided by an embodiment of the disclosure may be the network device in the above method, and the communication device includes a processor and a memory. The memory is configured to store a computer program, and the processor is configured to call the computer program from the memory and run the computer program, to perform the method for wireless communication performed by the network device.

An embodiment of the disclosure provides a chip, which is configured to perform the above method for wireless communication.

Specifically, the chip includes a processor configured to call a computer program from a memory and run the computer program, to cause a device equipped with the chip to perform the above method for wireless communication.

An embodiment of the disclosure provides a computer-readable storage medium, which is configured to store a computer program. Execution of the computer program causes a computer to perform the above method for wireless communication.

An embodiment of the disclosure provides a computer program product including computer program instructions. Execution of the computer program instructions causes a computer to perform the above method for wireless communication.

An embodiment of the disclosure provides a computer program that, when running on a computer, causes a computer to perform the above method for wireless communication.

In the above technical solutions, the first DCI sent from the network device to the terminal device is used for scheduling the at least two carriers, the first DCI has the first DCI format, the first indication field in the first DCI format indicates the scheduling information for each of the at least two carriers, and the bit width of the first indication field is determined based on the carriers capable of being simultaneously scheduled by the first DCI. In this way, the bit width of the first indication field is clearly defined, so that when the network device sends the first DCI to the terminal device, the terminal device can receive and parse the first indication field in the DCI based on the first bit width, which ensures the scheduling information indicated by the first indication field is correctly transmitted between the network device and the terminal device.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may implement the described functions for each specific application by use of different methods, but such implementation shall fall within the scope of the disclosure.

Those skilled in the art may clearly learn about that specific working processes of the system, device and unit described above may refer to the corresponding processes in the method embodiments and will not be elaborated herein for convenient and brief description.

In some embodiments provided by the disclosure, it is to be understood that the disclosed system, device and method may be implemented in another manner. For example, the device embodiment described above is only schematic, and for example, division of the units is only a logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection through some interfaces, devices or units, and may be electrical, mechanical or in other forms.

The units described as separate parts may or may not be physically separated, and parts displayed as units may or may not be physical units, and namely may be located in the same place, or may also be distributed onto multiple network units. Part or all of the units may be selected to achieve the purpose of the solutions in the embodiments according to a practical requirement.

In addition, functional units in each embodiment of the disclosure may be integrated into a processing unit, each unit may also exist physically and independently, or two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The abovementioned storage medium includes: various media capable of storing program codes such as a U disk, a mobile hard disk, a ROM, a RAM, a magnetic disk or an optical disk.

Described above are merely specific embodiments of the disclosure and the scope of protection of the disclosure is not limited thereto. Any variation or replacement easily conceivable by those skilled in the art within the technical scope disclosed by the disclosure shall fall within the scope of protection of the disclosure. Therefore, the scope of protection of the disclosure shall be subject to the scope of protection of the claims.

1. A method for wireless communication, the method comprising:
sending, by a network device, first Downlink Control Information (DCI) to a terminal device, wherein the first DCI is used for scheduling at least two cells simultaneously, the first DCI has a first DCI format, the first DCI format comprises a first indication field indicating scheduling information for each of the at least two cells, a bit width of the first indication field is a first bit width, and the first bit width is determined based on cells capable of being simultaneously scheduled by the first DCI.

2. The method of claim 1, wherein the first bit width is determined based on a first parameter and a second parameter, and the first parameter is determined based on the cells capable of being simultaneously scheduled by the first DCI.

3. The method of claim 2, wherein the first bit width is determined based on a product of the first parameter and the second parameter.

4. The method of claim 2, wherein the first parameter comprises at least one of:
a first number, wherein the first number is a maximum number of the cells capable of being simultaneously scheduled by the first DCI; or
a second number, wherein the second number is a number of cells contained in a first cell combination among at least one cell combination corresponding to the first DCI, and the first cell combination is a cell combination with a maximum number of cells among the at least one cell combination.

5. The method of claim 1, wherein the first bit width is determined based on a first parameter, the first parameter is determined based on the cells capable of being simultaneously scheduled by the first DCI.

6. The method of claim 5, wherein the first parameter is one of sixth numbers, each of the sixth numbers corresponds to a respective cell combination in a cell group or a first cell set, the sixth number is a sum of respective fifth numbers corresponding to all cells in the respective cell combination, each of the fifth numbers is determined based on configuration information for a respective one of the cells in the respective cell combination.

7. A network device, comprising: a processor and a memory, wherein the memory is configured to store a computer program, and the processor is configured to call the computer program from the memory and run the computer program, to sending first Downlink Control Information (DCI) to a terminal device, wherein the first DCI is used for scheduling at least two cells simultaneously, the first DCI has a first DCI format, the first DCI format comprises a first indication field indicating scheduling information for each of the at least two cells, a bit width of the first indication field is a first bit width, and the first bit width is determined based on cells capable of being simultaneously scheduled by the first DCI.

8. The network device of claim 7, wherein the first bit width is determined based on a first parameter and a second parameter, and the first parameter is determined based on the cells capable of being simultaneously scheduled by the first DCI.

9. The network device of claim 8, wherein the second parameter comprises at least one of:
a third number predefined by a protocol; or
a fourth number, wherein the fourth number is determined based on configuration information in the first indication field corresponding to respective cells in a cell group or a first cell set, and the first cell set is a set of cells corresponding to the first DCI format.

10. The network device of claim 9, wherein the fourth number is one of fifth numbers, each of the fifth numbers corresponds to a respective cell in the cell group or the first cell set, and the fifth number is determined based on the configuration information for the respective cell.

11. The network device of claim 10, wherein the fourth number is a maximum one or minimum one of the fifth numbers, each of the fifth numbers corresponding to a respective cell in the cell group or the first cell set.

12. The network device of claim 7, wherein the first bit width is determined based on a first parameter, the first parameter is determined based on the cells capable of being simultaneously scheduled by the first DCI.

13. The network device of claim 12, wherein the first parameter is one of sixth numbers, each of the sixth numbers corresponds to a respective cell combination in a cell group or a first cell set, the sixth number is a sum of respective fifth numbers corresponding to all cells in the respective cell combination, each of the fifth numbers is determined based on configuration information for a respective one of the cells in the respective cell combination.

14. A terminal device, comprising: a processor and a memory, wherein the memory is configured to store a computer program, and the processor is configured to call the computer program from the memory and run the computer program, to receive first Downlink Control Information (DCI) from a network device, wherein the first DCI is used for scheduling at least two cells simultaneously, the first DCI has a first DCI format, the first DCI format comprises a first indication field indicating scheduling information for each of the at least two cells, a bit width of the first indication field is a first bit width, and the first bit width is determined based on cells capable of being simultaneously scheduled by the first DCI.

15. The terminal device of claim 14, wherein the first bit width is determined based on a first parameter, the first parameter is determined based on the cells capable of being simultaneously scheduled by the first DCI.

16. The terminal device of claim 15, wherein the first parameter is one of sixth numbers, each of the sixth numbers corresponds to a respective cell combination in a cell group or a first cell set, the sixth number is a sum of respective fifth numbers corresponding to all cells in the respective cell combination, each of the fifth numbers is determined based on configuration information for a respective one of the cells in the respective cell combination.

17. The terminal device of claim 16, wherein the first parameter is a maximum one or minimum one of the sixth numbers, each of the sixth numbers corresponding to a respective cell combination in the cell group or the first cell set.

18. The terminal device of claim 14, wherein a number of valid bits contained in the first indication field in the first DCI is the first bit width or a second bit width, the second bit width is a bit width corresponding to a second cell combination scheduled by the first DCI, and the second cell combination comprises the at least two cells.

19. The terminal device of claim 18, wherein the second bit width is determined based on respective fifth numbers corresponding to cells in the second cell combination or is a seventh number corresponding to the second cell combination, the seventh number is a sum of respective fifth numbers corresponding to all cells in the second cell combination, and each of the fifth numbers is determined based on configuration information for a the respective one of the cells in the second cell combination.

20. The terminal device of claim 18, wherein the number of valid bits is less than or equal to the first bit width.
